(19) United States
(12) Patent Application Publication
(10) Pub. No.: US 2024/0338315 A1
(43) Pub. Date: Oct. 10, 2024

(54) SYSTEMS, METHODS, AND APPARATUS FOR COMPUTATIONAL DEVICE COMMUNICATION USING A COHERENT INTERFACE

(71) Applicant: Samsung Electronics Co., Ltd., Suwon-si (KR)

(72) Inventors: Changho CHOI, San Jose, CA (US); Yang Seok KI, Palo Alto, CA (US)

(21) Appl. No.: 18/627,438

(22) Filed: Apr. 4, 2024

Related U.S. Application Data
(60) Provisional application No. 63/457,398, filed on Apr. 5, 2023.

(51) Int. Cl. G06F 12/0831; G06F 9/50

(52) U.S. Cl. CPC G06F 12/0831; G06F 9/5016

(57) ABSTRACT

A method may include receiving, at a computational device, a command, wherein the computational device may include at least one computational resource, performing, using the at least one computational resource, based on the command, a computational operation, wherein the computational operation may generate a result, and sending, from the computational device, using a protocol of a communication interface, the result, wherein the communication interface may be configured to modify a copy of data stored at a first location based on modifying the data stored at a second location. The protocol may include a memory access protocol, and the sending the result may be performed using the memory access protocol. The protocol may include a cache protocol, and the sending the result may be performed using the cache protocol.

### REFERENCE TO RELATED APPLICATION

This application claims priority to, and the benefit of, U.S. Provisional Patent Application Ser. No. 63/457,398 filed Apr. 5, 2023 which is incorporated by reference.

### TECHNICAL FIELD

This disclosure relates generally to devices, and more specifically to systems, methods, and apparatus for computational device communication using a coherent interface.

### BACKGROUND

A storage device may include storage media to store information received from a host and/or other source. A computational storage device may include one or more compute resources to perform operations on data stored and/or received at the device. For example, a computational storage device may perform one or more computations that may be offloaded from a host.

The above information disclosed in this Background section is only for enhancement of understanding of the background of the inventive principles and therefore it may contain information that does not constitute prior art.

### SUMMARY

A method may include receiving, at a computational device, a command, wherein the computational device may include at least one computational resource, performing, using the at least one computational resource, based on the command, a computational operation, wherein the computational operation may generate a result, and sending, from the computational device, using a protocol of a communication interface, the result, wherein the communication interface may be configured to modify a copy of data stored at a first location based on modifying the data stored at a second location. The protocol may include a memory access protocol, and the sending the result may be performed using the memory access protocol. The protocol may include a cache protocol, and the sending the result may be performed using the cache protocol. The method may further include allocating, using the protocol, memory at the computational device, and storing, in the memory, at least a portion of the result. The command may be received using the protocol. The computational device may include a memory, and the method may further include accessing, using the protocol, at least a portion of the memory, and storing, in the at least a portion of the memory, the command. The communication interface may be a first communication interface, the protocol may be a first protocol, and the command may be received using a second protocol of a second communication interface.

An apparatus may include a computational device comprising a communication interface configured to modify a copy of data stored at a first location based on modifying the data stored at a second location, at least one computational resource, and a control circuit configured to receive a command, perform, using the at least one computational resource, based on the command, a computational operation, wherein the computational operation generates a result, and send, from the computational device, using a protocol of the communication interface, the result. The protocol may include a memory access protocol, and the control circuit may be configured to send the result using the memory access protocol. The protocol may include a cache protocol, and the control circuit may be configured to send the result using the cache protocol. The control circuit may be configured to allocate, using the protocol, memory at the computational device, and store, in the memory, at least a portion of the result. The control circuit may be configured to receive the command using the protocol. The computational device may include a memory, and the control circuit may be configured to access, using the protocol, at least a portion of the memory, and store, in the at least a portion of the memory, the command. The communication interface may be a first communication interface, the protocol may be a first protocol, the computational device may include a second communication interface, and the control circuit may be configured to receive, using a second protocol of the second communication interface, the command.

An apparatus may include a communication interface configured to modify a copy of data stored at a first location based on modifying the data stored at a second location, and a control circuit configured to send, to a computational device, a command to perform a computational operation, and receive, using a protocol of the communication interface, a result of the computational operation. The protocol may include a memory access protocol, and the control circuit may be configured to receive the result using the memory access protocol. The protocol may include a cache protocol, and the control circuit may be configured to receive the result using the cache protocol. The control circuit may be configured to allocate, using the protocol, for at least a portion of the result of the computational operation, memory at the computational device. The control circuit may be configured to send the command using the protocol. The communication interface may be a first communication interface, the protocol may be a first protocol, the apparatus may include a second communication interface, and the control circuit may be configured to send, using a second protocol of the second communication interface, the command.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of a computational device scheme in accordance with example embodiments of the disclosure.

FIG. 2 illustrates an example embodiment of a computational device scheme in accordance with example embodiments of the disclosure.

FIG. 3 illustrates an embodiment of a computational device scheme having two access modes in accordance with example embodiments of the disclosure.

FIG. 4 illustrates another embodiment of a multi-mode computational device access scheme in accordance with example embodiments of the disclosure.

FIG. 5 illustrates an embodiment of a protocol stack in accordance with example embodiments of the disclosure.

FIG. 6 illustrates an example embodiment of a computational device scheme using a coherent interface in accordance with example embodiments of the disclosure.

FIG. 7 illustrates an embodiment of a coherent interface scheme using a cache protocol in accordance with example embodiments of the disclosure.

FIG. 8 illustrates a first embodiment of a computational device scheme using a coherent interface to transfer a result of an operation in accordance with example embodiments of the disclosure.

FIG. 9 illustrates a second embodiment of a computational device scheme using a coherent interface to transfer a result of an operation in accordance with example embodiments of the disclosure.

FIG. 10 illustrates a third embodiment of a computational device scheme using a coherent interface to transfer a result of an operation in accordance with example embodiments of the disclosure.

FIG. 11 illustrates a fourth embodiment of a computational device scheme using a coherent interface to transfer a result of an operation in accordance with example embodiments of the disclosure.

FIG. 12 illustrates an embodiment of a method for computational device communication using a coherent interface in accordance with example embodiments of the disclosure.

### DETAILED DESCRIPTION

A computational storage device (CSD) may communicate results of computations using a protocol (e.g., a storage protocol) that may transfer data in units of blocks that may have a block size such as 4096 (4K) bytes. Some computation results, however, may be smaller than a block size. Therefore, it may be inefficient to transfer computation results using a storage protocol because the storage protocol may transfer a block even though the computation results may not fill the block. Some computational storage devices may communicate computation results using a direct memory transfer (DMA) scheme which may transfer information, for example, from memory in a device to memory at a host. DMA transfers, however, may involve relatively high overhead.

A computational device scheme in accordance with example embodiments of the disclosure may use a coherent protocol to communicate computation results. For example, a computational device may store a computation result in a memory area that may be configured to transfer information to a host using a coherent protocol that may implement a memory access protocol that a host may use to request the computation result. Additionally, or alternatively, a computational device in accordance with example embodiments of the disclosure may store a computation result in a memory area that may be configured to transfer information to a host using a coherent protocol that may implement a cache protocol. In such an embodiment, computation results may be transferred from the computational device to the host automatically, for example, using a cache snooping scheme.

Some computational device schemes in accordance with example embodiments of the disclosure may allocate memory for a computation result using a coherent protocol. For example, a host may use a coherent protocol that may implement a memory access protocol to allocate a memory area for computation results at a computational device. In such an embodiment, computation results stored in the memory area may be transferred from the computational device to the host using a coherent protocol that may implement the memory access protocol, a cache protocol, and/or the like.

Additionally, or alternatively, a computational device scheme in accordance with example embodiments of the disclosure may provide one or more commands to a computational device using a coherent protocol. For example, a host may use a coherent protocol that may implement an input and/or output (I/O) protocol to transfer one or more commands to a computational device. In some embodiments, one or more commands may be transferred using a storage protocol that may use the I/O protocol as an underlying transport layer, link layer, and/or the like.

Some computational device schemes in accordance with example embodiments of the disclosure may use one or more memory areas configured as one or more queues (e.g., a submission queue (SQ), a completion queue (CQ), and/or the like) to transfer commands, completions, and/or the like using a coherent protocol. For example, a memory area in a computational device may be configured as a cache that may be accessed using a coherent protocol that may implement a cache protocol. One or more command queues (e.g., a command submission queue and/or a command completion queue) may be located in the memory area and accessed using the cache protocol. Depending on the implementation details, the computational device may automatically detect a command in a submission queue, for example, using a cache snooping scheme, and process the command. Additionally, or alternatively, a host may automatically detect a completion in a completion queue, for example, using a cache snooping scheme.

Depending on the implementation details, the use of a coherent protocol to transfer a computation result may improve performance, for example, by reducing latency, increasing throughput, reducing overhead, reducing power consumption, and/or the like.

This disclosure encompasses numerous aspects relating to the use of one or more protocols with computational storage schemes. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as specific interfaces, protocols, and/or the like. However, the aspects of the disclosure are not limited to these or any other implementation details.

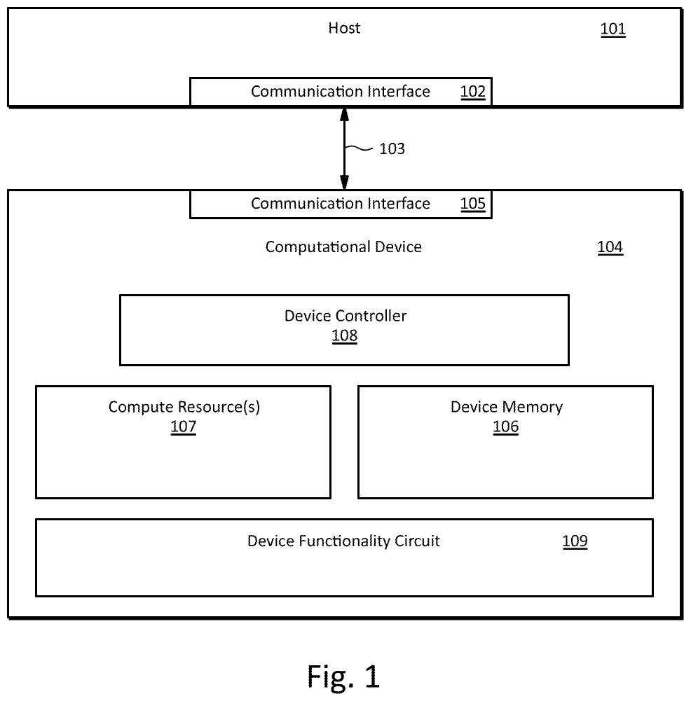

FIG. 1 illustrates an embodiment of a computational device scheme in accordance with example embodiments of the disclosure. The embodiment illustrated in FIG. 1 may include one or more hosts 101 and one or more computational devices 104 configured to communicate using one or more communication connections 103.

A host 101 may be implemented with any component or combination of components that may utilize one or more features of a computational device 104. For example, a host may be implemented with one or more of a server, a storage node, a compute node, a central processing unit (CPU), a workstation, a personal computer, a tablet computer, a smartphone, and/or the like, or multiples and/or combinations thereof.

A computational device 104 may include a communication interface 105, memory 106 (some or all of which may be referred to as device memory), one or more compute resources 107 (which may also be referred to as computational resources), a device controller 108, and/or a device functionality circuit 109. The device controller 108 may control the overall operation of the computational device 104 including any of the operations, features, and/or the like, described herein. For example, in some embodiments, the device controller 108 may parse, process, invoke, and/or the like, commands received from the host 101.

The device functionality circuit 109 may include any hardware to implement the primary function of the computational device 104. For example, if the computational device 104 is implemented as a storage device (e.g., a computational storage device), the device functionality circuit 109 may include storage media such as magnetic media (e.g., if the computational device 104 is implemented as a hard disk drive (HDD) or a tape drive), solid state media (e.g., one or more flash memory devices), optical media, and/or the like. For instance, in some embodiments, a storage device may be implemented at least partially as a solid state drive (SSD) based on not-AND (NAND) flash memory, persistent memory (PMEM) such as cross-gridded nonvolatile memory, memory with bulk resistance change, phase change memory (PCM), or any combination thereof. In an embodiment in which the computational device 104 is implemented as a storage device, the device controller 108 may include a media translation layer such as a flash translation layer (FTL) for interfacing with one or more flash memory devices. In some embodiments, a computational storage device may be implemented as a computational storage drive, a computational storage processor (CSP), and/or a computational storage array (CSA).

As another example, if the computational device 104 is implemented as a network interface controller (NIC), the device functionality circuit 109 may include one or more modems, network interfaces, physical layers (PHYs), medium access control layers (MACs), and/or the like. As a further example, if the computational device 104 is implemented as an accelerator, the device functionality circuit 109 may include one or more accelerator circuits, memory circuits, and/or the like.

The compute resources 107 may be implemented with any component or combination of components that may perform operations on data that may be received, stored, and/or generated at the computational device 104. Examples of compute engines may include combinational logic, sequential logic, timers, counters, registers, state machines, complex programmable logic devices (CPLDs), field programmable gate arrays (FPGAs), application specific integrated circuits (ASICs), embedded processors, microcontrollers, central processing units (CPUs) such as complex instruction set computer (CISC) processors (e.g., x86 processors) and/or a reduced instruction set computer (RISC) processors such as ARM processors, graphics processing units (GPUs), data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

The memory 106 may be used, for example, by one or more of the compute resources 107 to store input data, output data (e.g., computation results), intermediate data, transitional data, and/or the like. The memory 106 may be implemented, for example, with volatile memory such as dynamic random access memory (DRAM), static random access memory (SRAM), and/or the like, as well as any other type of memory such as nonvolatile memory.

In some embodiments, the memory 106 and/or compute resources 107 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in a repository in memory 106 and/or compute resources 107. Software, instructions, programs, code, and/or the like, may be downloaded, uploaded, sideloaded, pre-installed, built-in, and/or the like, to the memory 106 and/or compute resources 107. In some embodiments, the computational device 104 may receive one or more instructions, commands, and/or the like, to select, enable, activate, execute, and/or the like, software, instructions, programs, code, and/or the like. Examples of computational operations, functions, and/or the like, that may be implemented by the memory 106, compute resources 107, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for artificial intelligence (A/I), machine learning (ML), neural networks, and/or the like.

A communication interface 102 at a host 101, a communication interface 105 at a device 104, and/or a communication connection 103 may implement, and/or be implemented with, one or more interconnects, one or more networks, a network of networks (e.g., the internet), and/or the like, or a combination thereof, using any type of interface, protocol, and/or the like. For example, the communication connection 103, and/or one or more of the interfaces 102 and/or 105 may implement, and/or be implemented with, any type of wired and/or wireless communication medium, interface, network, interconnect, protocol, and/or the like including Peripheral Component Interconnect Express (PCIe), Nonvolatile Memory Express (NVMe), NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like. Advanced extensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 103 may include one or more switches, hubs, nodes, routers, and/or the like.

A computational device 104 may be implemented in any physical form factor. Examples of form factors may include a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like). Next-generation Small Form Factor (NGSFF), NF1 form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), and/or the like.

Any of the computational devices disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a computational device 104 may be implemented with any device that may include, or have access to, memory, storage media, and/or the like, to store data that may be processed by one or more compute resources 107. Examples may include memory expansion and/or buffer devices such as CXL type 2 and/or CXL type 3 devices, as well as CXL type 1 devices that may include memory, storage media, and/or the like.

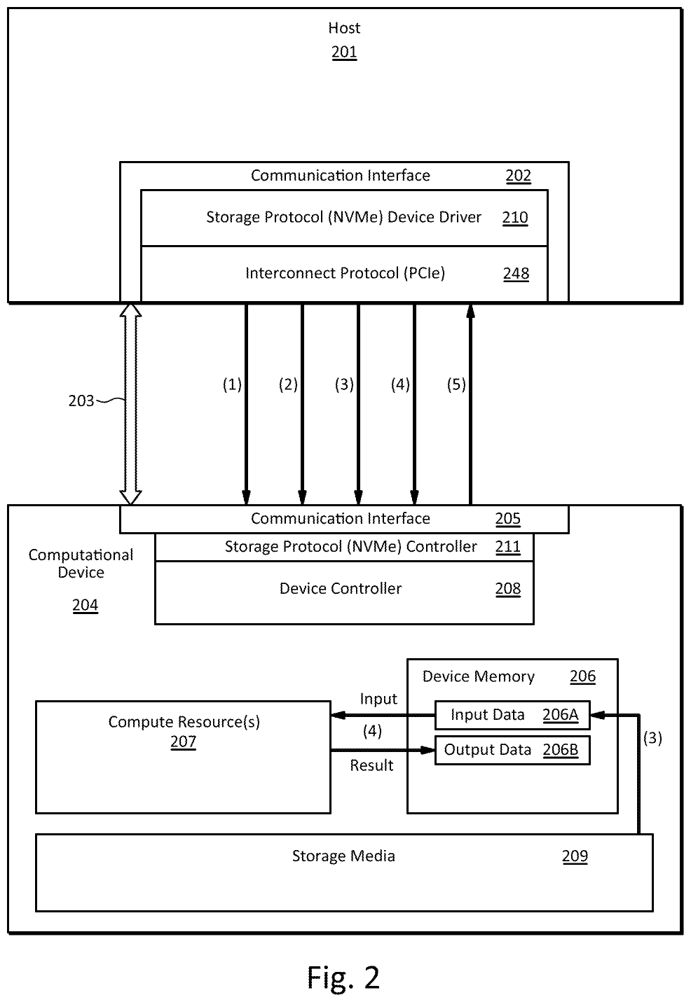

FIG. 2 illustrates an example embodiment of a computational device scheme in accordance with example embodiments of the disclosure. The embodiment illustrated in FIG. 2 may be used to implement, or be implemented with, the embodiment illustrated in FIG. 1 in which similar elements may be indicated by reference numbers ending in, and/or containing, the same digits, letters, and/or the like.

The embodiment illustrated in FIG. 2 may include a host 201 and/or a computational device 204 configured to communicate using a communication link 203. In some embodiments, the computational device 204 may be implemented as a computational storage device in which a device functionality circuit may be implemented at least in part with storage media (e.g., NAND flash media) 209 as illustrated in FIG. 2.

The communication connection 203 may be implemented, for example, with a PCIe link having any number of lanes (e.g., X1, X4, X8, X16, and/or the like). The host 201 may include a communication interface 202, and the computational device 204 may include a communication interface 205 that may implement an interconnect interface and/or protocol such as PCIe. A protocol stack at the host 201 may include an interconnect (e.g., PCIe) layer 248 and/or a device driver 210 that may implement a storage protocol (e.g., an NVMe protocol as illustrated in FIG. 2) that may operate over the underlying PCIe protocol, transport layer, link layer, physical layer, and/or the like. The communication interface 205 and/or the device controller 208 at the computational device 204 may include one or more storage protocol controllers 211 (e.g., an NVMe controller) that may implement one or more storage protocol subsystems (e.g., NVMe subsystems) that may enable the host 201 and the computational device 204 to communicate using an NVMe protocol over a PCIe link implemented by the communication interfaces 202 and/or 205.

The embodiment illustrated in FIG. 2 may be used to implement a computational operation as follows. The host 201 (e.g., an application, process, service, virtual machine (VM), VM manager, operating system, and/or the like, running on the host 201) may communicate with the computational device 204, for example, using the device driver 210 to implement an NVMe protocol over a PCIe link implemented with the PCIe interface 202. At operation (1), the host 201 may send one or more commands, instructions, and/or the like, using an NVMe protocol (which may be referred to individually and/or collectively as a command, e.g., a configuration command) to configure the computational device 204 to perform a computational operation on data stored in the storage media 209. For example, the configuration command may cause the computational device 204 to download (e.g., from the host 201 and/or another source) a computational program. FPGA code, and/or the like, that may be used by the compute resources 207 to perform the computational operation. Additionally, or alternatively, the configuration command may select, enable, activate, and/or the like) a computational program, FPGA code, and/or the like, that may be present at the computational device 204.

At operation (2), the host 201 may send a command (e.g., an allocate command using an NVMe protocol) to allocate a first portion of the memory 206 as shared memory 206A to store input data for the computational operation. For example, the NVMe controller 211 may implement an NVMe subsystem using the portion 206A of memory 206 as subsystem local memory (SLM), for example, as shared SLM.

At operation (3), the host 201 may send a command (e.g., a load data command using an NVMe protocol) to cause the computational device 204 to load input data for the computational operation from the storage media 209 to the shared memory 206A.

At operation (4), the host 201 may send a command (e.g., an execute command using an NVMe protocol) to cause at least a portion of the compute resources 207 to perform the computational operation using the input data stored in the shared memory 206A. One or more results (e.g., output data) of the computational operation may be stored, for example, in a second portion of the memory 206 that may be configured as shared memory 206B. The computational operation may use one or more memory pointers to determine the location(s) of the input shared memory 206A and/or output shared memory 206B. In some embodiments, one or more pointers to shared memory 206A and/or output shared memory 206B may be sent with, indicated by, and/or the like, an execute command.

At operation (5), the host 201 may read one or more results (e.g., output data) from the output shared memory 206B, for example, using DMA. The read operation may be initiated, for example, by the host 201 sending a command (e.g., a read command using an NVMe protocol) to the computational device 204 which may transfer the one or more results by performing a DMA transfer over the PCIe link 203.

In some embodiments, the NVMe protocol, PCIe interface 205, and/or DMA mechanism may be configured to transfer data in blocks that may have a block size such as 4096 (4K) bytes. The one or more results of the computational operation, however, may be smaller than the size of a block size. Therefore, the read operation (5) may transfer more data than the results of the computational operation. Moreover, the DMA transfer may involve relatively high overhead that may be caused, for example, by operations for resolving addresses, accessing translation tables, and/or the like. Depending on the implementation details, the use of block data transfers and/or DMA transfers may increase latency, reduce throughput and/or bandwidth, increase power consumption, and/or the like.

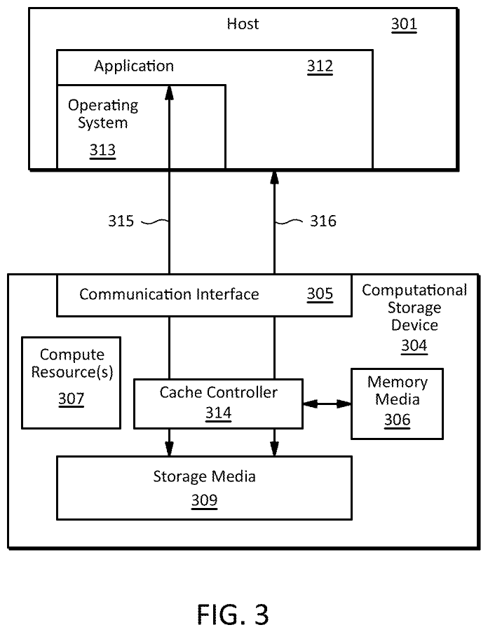

FIG. 3 illustrates an embodiment of a computational device scheme having two access modes in accordance with example embodiments of the disclosure. The embodiment illustrated in FIG. 3 may include one or more elements that may, in some aspects, be similar to, the embodiments illustrated in FIG. 1 or FIG. 2 in which similar elements may be indicated by reference numbers ending in, and/or containing, the same digits, letters, and/or the like.

The embodiment illustrated in FIG. 3 may include a host 301 and/or a computational device which, in this embodiment, may be implemented as a computation storage device 304.

The host 301 may include a communication interface 302 and one or more processors that may run an operating system 312 and/or an application 313.

The computational storage device 304 may include a communication interface 305, one or more compute resources 307, memory 306 (e.g., DRAM), a device functionality circuit which, in this embodiment, may be implemented at least partially with storage media 309, and/or a cache controller 314. In some embodiments, memory 306 may be addressable in relatively small units such as bytes, words, cache lines, flits, and/or the like, whereas storage media 309 may be addressable in relatively large units such as pages, blocks, sectors, and/or the like.

The computational storage device 304 may be configured to enable the host 301 to access the storage media 309 as storage using a first data transfer mechanism 315, or as memory using a second data transfer mechanism 316. In one example embodiment, the communication interface 305 may implement the first data transfer mechanism 315 using a storage protocol such as NVMe running over a coherent interface such as CXL using an I/O) protocol such as CXL.io. Alternatively, or additionally, the communication interface 305 may implement the first data transfer mechanism 315 using a storage protocol such as NVMe running over an interconnect interface such as PCIe.

The communication interface 305 may implement the second data transfer mechanism 316 using a coherent interface such as CXL using a memory access protocol such as CXL.mem and/or a cache protocol such as CXL.cache. The configuration illustrated in FIG. 3 may enable the operating system (e.g., Linux) 313 to access the storage media 309 as storage, for example, using a file system based access scheme that supports an NVMe protocol running over CXL.io. For example, a file system in the operating system 313 may access data in the storage media 309 using NVMe read and/or write commands that may read data from, and/or write data to, the storage media 309 in units of one or more pages.

The configuration illustrated in FIG. 3 may also enable the application 312 to access the storage media 309 as memory, for example, with memory load/store instructions using CXL.mem and/or CXL.cache. In some embodiments, the cache controller 314 may configure a portion of the memory media 306 as a cache for the storage media 309. For example, because memory load and/or store commands may access data in relatively small units such as bytes, words, cache lines, flits, and/or the like, and because storage read and/or write commands may access the storage media 309 in relatively larger units such as pages, blocks, sectors, and/or the like, the computational storage device 304 may service a memory load command for data (e.g., a byte, word, cache line, flit, and/or the like) in the storage media 309 by reading a page, block, sector, and/or the like, containing the requested data from the storage media 309 and storing the page, block, sector, and/or the like in a cache (e.g., in a portion of memory media 306). The computational storage device 304 may extract the requested data from the cache and return it to the host 301 using the CXL.mem protocol and/or the CXL.cache protocol in response to the memory load command.

The embodiment illustrated in FIG. 3 may be used, for example, to implement a memory mapped storage scheme in accordance with example embodiments of the disclosure. Depending on the implementation details, such a scheme may improve performance (e.g., reduce latency) compared, for example, to a memory mapped file scheme implemented by an operating system. For example, an operating system such as Linux may implement a memory mapped file scheme in which, for an application running at a host to read, as memory, data in a file stored in storage media at a storage device, the operating system may read, as storage, a sector from the storage media using an NVMe protocol. The operating system may then store the sector in main memory (e.g. DRAM) from which the application may load the requested data.

However, in the multi-mode access scheme illustrated in FIG. 3, the operating system 313 may be configured to enable the application 312 to access, as memory, a file stored in the storage media 309 relatively directly, for example, by bypassing one or more operations of the operating system 313 and using the second data transfer mechanism 316 (e.g., using CXL.mem and/or CXL.cache). For instance, in an example storage access operation, the application 312 may send a memory load command (e.g., using CXL which may bypass the operating system 313) to the storage device 304 to request a byte of data in the storage media 309. If the requested byte of data is stored in a cache (e.g., in a portion of memory media 306), the cache controller 314 may read the requested data from the cache and return the requested data in response to the memory load command. However, even if the requested data is not stored in a cache, and the cache controller 314 uses a storage read command to read a page containing the requested byte of data from the storage media 309 (which may then be stored in a cache from which the memory load command may be serviced), the memory load command may still bypass the operating system 313. Depending on the implementation details, this may reduce overhead, power consumption, latency, and/or the like, associated with an operating system transferring a sector to host memory. Using the second data transfer mechanism 316 (e.g., using CXL.mem and/or CXL.cache) may also result in a faster data transfer compared, for example, to using a storage protocol such as NVMe running over a PCIe or CXL.io transport scheme which, depending on the implementation details, may be relatively slow.

Although the multi-mode access scheme illustrated in FIG. 3 may be described in the context of a computational storage device 304, a similar multi-mode access scheme in accordance with example embodiments of the disclosure may also be implemented with a computational device implemented, for example, as a NIC, an accelerator, and/or any other type of computational device.

Moreover, the multi-mode access scheme illustrated in FIG. 3 may be described in a context in which storage media 309 may be accessed using a first data transfer mechanism 315 which may be implemented with a storage protocol (e.g., NVMe) over an interconnect interface such as PCIe and/or over a coherent interface (e.g., CXL) implementing an I/O protocol (e.g., CXL.io). In other embodiments, however, other resources such as device memory 306 and/or any other device functionality that may be implemented with a device functionality circuit 309 (e.g., a NIC, an accelerator, one or more compute resources 307, and/or the like) may be accessed using a first data transfer mechanism 315 and/or a second data transfer mechanism 316 as described above. For example, in some embodiments, either or both of the first data transfer mechanism 315 and/or second data transfer mechanism 316 may be used to allocate memory 306, configure one or more compute resources 307, transfer one or more commands (e.g., to load input data to memory 306, execute a computational operation using one or more compute resources 307, and/or transfer one or more results to a host 301), and/or the like.

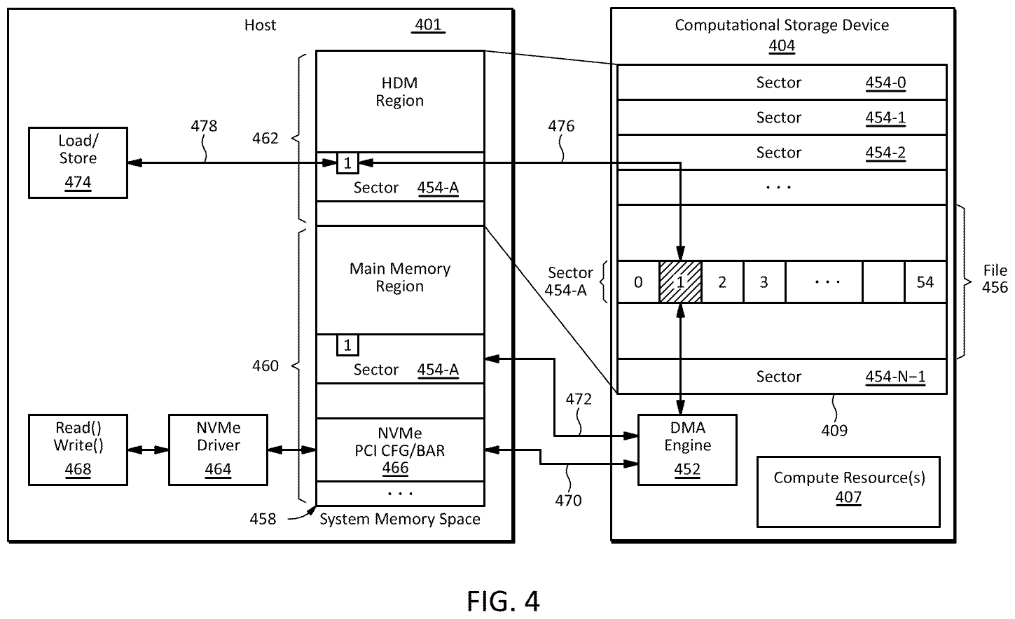

FIG. 4 illustrates another embodiment of a multi-mode computational device access scheme in accordance with example embodiments of the disclosure. The embodiment illustrated in FIG. 4 may include a computational device implemented as a computational storage device 404 having one or more compute resources 407, a DMA engine 452 and/or a device functionality circuit implemented with storage media 409. For purposes of illustration, the storage media 409 illustrated in FIG. 4 may be accessed in units of sectors. However, other embodiments may access storage media 409 in units of pages, blocks, and/or the like.

Data may be stored in the storage media 409 as sectors 454 0, 454-1, . . . , 454-N−1 (which may be referred to collectively and/or individually as 454). A sector may include, for example, 512 bytes numbered 0 through 511. A memory mapped file 456 may be stored in one or more sectors 454 including sector 454-A which may include data of interest stored in byte 1.

A host 401 may include a system memory space 458 having a main memory region 462 that may be implemented, for example, with dual inline memory modules (DIMMS) on a circuit board (e.g., a host motherboard). Some or all of the storage media 409 may be mapped, using a coherent interface such as CXL implementing a memory access protocol such as CXL.mem and/or a cache protocol such as CXL.cache, as host managed device memory (HDM) 462 to a region of the system memory space 458.

The host 401 (or an application, process, service, VM, VM manager, and/or the like, running on the host) may access data in the memory mapped file 456 as storage using a first access mode (which may also be referred to as a method) or as memory using a second access mode.

The first mode may be implemented by an operating system running on the host 401. The operating system may implement the first mode with a storage access protocol such as NVMe using an NVMe driver 464 at the host 401. The NVMe protocol may be implemented with an underlying transport scheme based, for example, PCIe and/or CXL.io which may use a PCIe physical layer. The NVMe driver 464 may use a portion 466 of system memory 458 for PCIe configuration (PCI CFG), base address registers (BAR), and/or the like.

An application (or other user) may access data in the file 456 in units of sectors (or blocks, pages, and/or the like) using one or more storage read/write instructions 468. For example, to read the data stored in byte 1 in sector 454-A of file 456, an application (or other user) may issue, to the NVMe driver 464, a storage read command 468 for the sector 454-A that includes byte 1. The NVMe driver 464 may initiate a DMA transfer by the DMA engine 452 as shown by arrow 470. The DMA engine 452 may transfer the sector 454-A to the main memory region 460 of system memory 458 as shown by arrow 472. The application may access byte 1 by reading it from the main memory region 460.

The second mode may be implemented with a coherent interface such as CXL implementing a memory access protocol such as CXL.mem and/or a cache protocol such as CXL.cache which may map the storage media 409 as host managed device memory 462 to a region of the system memory space 458. Thus, the sector 454-A including byte 1 may be mapped to the HDM region 462.

An application (or other user) may also access data in the file 456 in units of bytes (or words, cache lines, flits, and/or the like) using one or more memory load/store instructions 474. For example, to read the data stored in byte 1 of the file 456, an application (or other user) may issue a memory load command 474. The data stored in byte 1 may be transferred to the application using, for example, the CXL.mem protocol and/or the CXL.cache protocol as shown by arrows 476 and 478.

Depending on the implementation details, accessing the data stored in byte 1 of the file 456 using the second mode (e.g., using CXL) may reduce latency (especially, in some embodiments, when accessing data in relatively small units), increase bandwidth, reduce power consumption, and/or the like, for any number of the following reasons. In a coherent interface scheme such as CXL, a sector may be mapped, rather than copied to system memory, thereby reducing data transfers. In a coherent interface scheme, data may be byte addressable, thereby reducing the amount of data transferred to access the data of interest in byte 1 as compared to copying an entire sector to system memory. A coherent interface scheme may provide an application or other user may more direct access to data, for example, by bypassing some or all of an operating system as also illustrated in FIG. 13. As with the embodiment described above with respect to FIG. 13, in the embodiment illustrated in FIG. 4, data accessed in a sector 454 using memory load/store instructions 474 may be accessed using a cache that may be implemented with memory media that may be located, for example, in the computational storage device 404, system memory space 458, and/or the like. Such a cache configuration may be used, for example, because the sectors 454 or other storage media in a computational storage device may be accessible (e.g., only accessible) in units of sectors, blocks, pages, and/or the like, whereas a memory load/store command 474 may access data in units of bytes, words, cache lines, and/or the like.

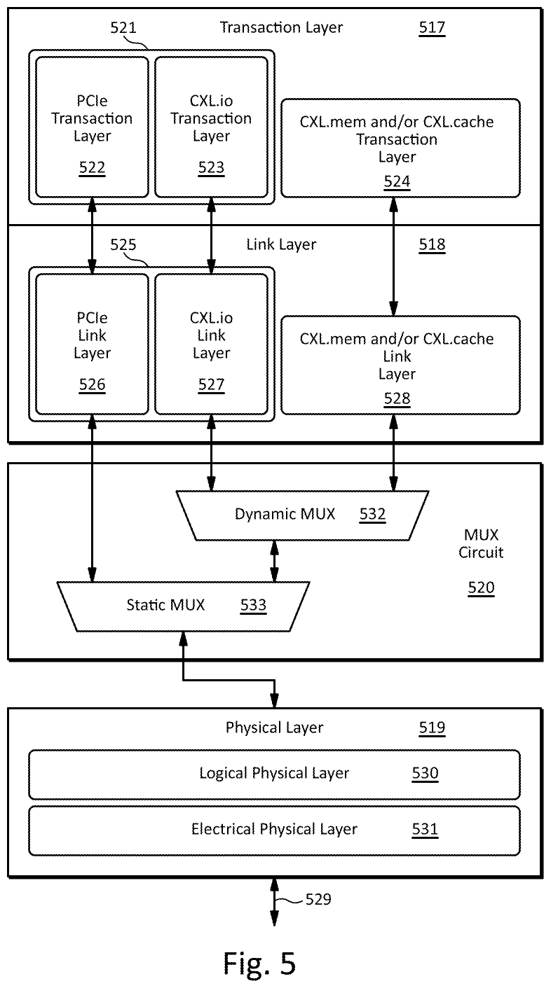

FIG. 5 illustrates an embodiment of a protocol stack in accordance with example embodiments of the disclosure. For purposes of illustration, the embodiment illustrated in FIG. 5 may be described in the context of an interconnect scheme implemented with PCIe and/or a coherent interface implemented with CXL, but interconnect schemes and/or coherent interfaces may be used.

The protocol stack illustrated in FIG. 5 may include a transaction layer 517, a link layer 518, a physical layer 519, and/or an arbitration and/or multiplexing and/or demultiplexing circuit 520 (which may also be referred to as a multiplexer, a MUX, an ARB/MUX circuit, a MUX circuit, and/or the like).

The transaction layer 517 may include a first portion 521 (which may be referred to as a PCIe/CXL transaction layer) that may include logic to implement a PCIe transaction layer 522 and/or a CXL.io transaction layer 523. In some embodiments, some or all of the CXL.io transaction layer 523 may be implemented as an extension, enhancement, and/or the like, of some or all of the PCIe transaction layer 522. Although shown as separate components, in some embodiments, a PCIe transaction layer 522 and CXL.io transaction layer 523 may be converged into one component. The transaction layer 517 may include a second portion 524 (which may be referred to as a CXL.mem/CXL.cache transaction layer, a CXL.cachemem transaction layer, and/or the like) that may include logic to implement a CXL.mem and/or CXL.cache transaction layer.

The transaction layer 517 may implement transaction types, transaction layer packet formatting, transaction ordering rules, and/or the like. In some embodiments, the CXL.io transaction layer 523 may be similar, for example, to a PCIe transaction layer 522. For CXL.mem, the CXL.mem/CXL.cache transaction layer 524 may implement message classes (e.g., in each direction), one or more fields associated with message classes, message class ordering rules, and/or the like. For CXL.cache, the CXL.mem/CXL.cache transaction layer 524 may implement one or more channels (e.g., in each direction) such as channels for request, response, data, and/or the like, transaction opcodes that may flow through a channel, channel ordering rules, and/or the like.

The link layer 518 may include a first portion 525 (which may be referred to as a PCIe/CXL link layer) that may include logic to implement a PCIe link layer 526 (which may also be referred to as a data link layer) and/or a CXL.io link layer 527. In some embodiments, some or all of the CXL.io link layer 527 may be implemented as an extension, enhancement, and/or the like, of some or all of the PCIe link layer 526. Although shown as separate components, in some embodiments, a PCIe link layer 526 and CXL.io link layer 527 may be converged into one component. The link layer 518 may include a second portion 528 (which may be referred to as a CXL.mem/CXL.cache link layer, a CXL.cachemem link layer, and/or the like) that may include logic to implement a CXL.mem and/or CXL.cache link layer.

The link layer 518 may implement transmission of transaction layer packets across a physical link 529 (e.g., one or more physical lanes). In some embodiments, the link layer 518 may implement one or more reliability mechanisms such as a retry mechanism, cyclical redundancy check (CRC) code calculation and/or checking, control flits, and/or the like. In some embodiments, the CXL.io link layer 527 may be similar, for example, to a PCIe link layer 526. For CXL.mem and/or CXL.cache, the CXL.mem/CXL.cache link layer 528 may implement one or more flit formats, flit packing rules (e.g., for selecting transactions from internal flit queues to fill slots), and/or the like.

The physical layer 519 (which may also be referred to as a PHY or Phy layer) may implement, operate, train, and/or the like, a physical link 529, for example, to transmit PCIe packets, CXL flits, and/or the like. The physical layer 519 may include a logical physical layer 530 (which may also be referred to as a logical PHY, logPHY, or a LogPhy layer) and/or an electrical physical layer 531 (which may also be referred to as an analog physical layer). In some embodiments, on a transmitting side of a link, the logical physical layer 530 may prepare data from a link layer for transmission across a physical link 529. On a receiving side of a link, the logical physical layer 530 may convert data received from the link to an appropriate format to pass on to the appropriate link layer. In some embodiments, the logical physical layer 530 may perform framing of flits and/or physical layer packet layout for one or more flit modes.

The electrical physical layer 531 may include one or more transmitters, receivers, and/or the like to implement one or more lanes. A transmitter may include one or more components such as one or more drivers to drive electrical signals on a channel, a deskew circuit, clock circuitry, and/or the like. A receiver may include one or more components such as one or more amplifiers and/or sampling circuits to receive data signals, clock signals, and/or the like), a deskew circuit, clock circuitry (e.g., a clock recovery circuit), and/or the like.

In some embodiments, the logical physical layer 530 may be implemented at least partially as a converged logical physical layer that may operate in a PCIe mode, a CXL mode, and/or the like, depending, for example, on an operating mode of the transaction layer 517 and/or the link layer 518.

The MUX circuit 520 may be configured to perform one or more types of arbitration, multiplexing, and/or demultiplexing (which may be referred to individually and/or collectively as multiplexing) of one or more protocols to transfer data over a physical link 529. In some embodiments, the MUX circuit 520 may include a dynamic multiplexing circuit 532 that may dynamically multiplex transfers using one or more of the CXL.io, CXL.mem, and/or CXL.cache protocols onto the physical link 529. For example, after the physical link 529 has been configured, trained, and/or the like, the dynamic multiplexing circuit 532 may interleave transactions using one or more of the CXL.io, CXL.mem, and/or CXL.cache protocols onto the physical link 529, depending on the implementation details, without reconfiguring, retraining, and/or the like, the physical link 529.

In some embodiments, the MUX circuit 520 may include a static multiplexing circuit 533 that may statically multiplex transactions using one or more of the CXL protocols (e.g., CXL.io, CXL.mem, and/or CXL.cache) with transactions using a PCIe protocol onto the physical link 529. For example, in some embodiments, the physical link 529 may be reconfigured, retrained, and/or the like, between transactions using a CXL protocol and transactions using a PCIe protocol.

The protocol stack illustrated in FIG. 5, or one or more portions thereof, may be used, for example, to implement any of the computational device schemes described in this disclosure. In some embodiments, one or more portions of the protocol stack illustrated in FIG. 5 may be omitted, and/or one or more additional portions may be included. For example, some embodiments may omit the PCIe transaction layer 522 and/or the PCIe link layer 526.

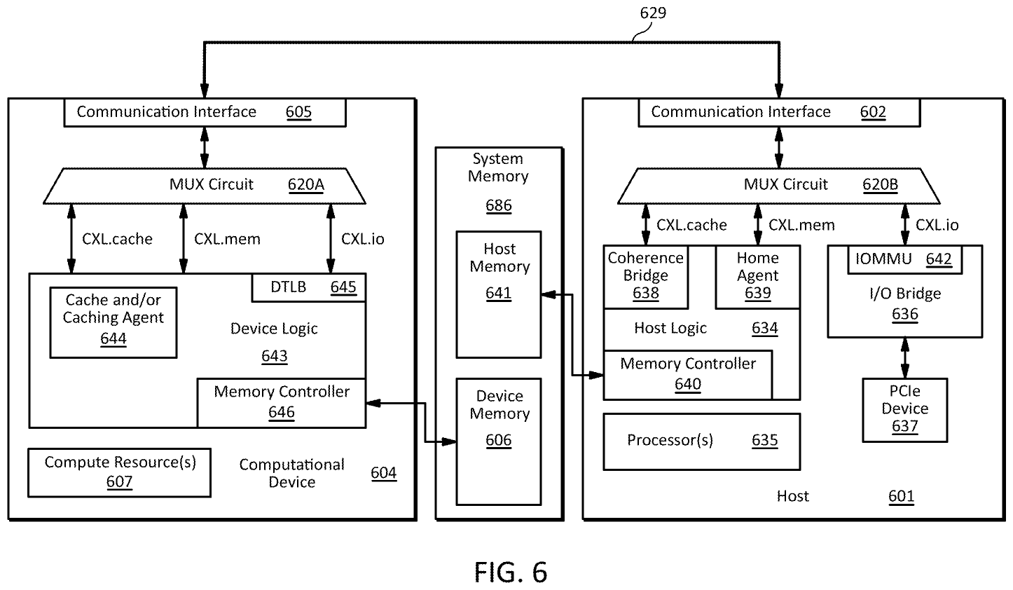

FIG. 6 illustrates an example embodiment of a computational device scheme using a coherent interface in accordance with example embodiments of the disclosure. The embodiment illustrated in FIG. 6 may be used, for example, to implement, and/or may be implemented with, the stack illustrated in FIG. 5 in which similar elements may be indicated by reference numbers ending in, and/or containing, the same digits, letters, and/or the like.

The embodiment illustrated in FIG. 6 may include a host 601 and/or a computational device 604 configured to communicate using one or more communication links 629. The host 601 may include a communication interface 602 and the device 604 may include a communication interface 605. The communication interfaces 602 and 605 may be configured to implement a coherent interface (e.g., CXL) that may implement one or more protocols such as an I/O protocol, a memory access protocol, and/or a cache protocol (e.g., using CXL.io, CXL.mem, and/or CXL.cache, respectively) which, depending on the implementation details, may be multiplexed (e.g., dynamically multiplexed) over one or more physical links 629 (e.g., in some embodiments, over a single physical link). In some embodiments, the coherent interface and/or one or more protocols may be implemented, for example, using a stack architecture such as that described with respect to FIG. 5. In some embodiments, a coherent interface may refer to an interface that may implement one or more protocols, at least one of which may implement, use, and/or the like, a coherency mechanism. For example, in some embodiments, a coherent interface such as CXL may implement a memory access protocol (e.g., CXL.mem) and/or a cache protocol (e.g., CXL.cache) using one or more coherency mechanisms, whereas it may implement an I/O protocol (e.g., CXL.io) as a non-coherent protocol. In some embodiments, coherent or coherency may refer to modifying a first copy of data stored at a first location based on modifying a second copy of the data stored at a second location.

Referring to FIG. 6, the host 601 may include host logic 634, one or more processors 635, an I/O bridge 636, one or more PCIe devices 637, and/or a multiplexing circuit 620B. The host logic 634 may implement any of the host functionality described herein. For example, the host logic 634 may implement coherence and/or cache logic for a memory access protocol (e.g., CXL.mem) and/or a cache protocol (e.g., CXL.cache).

In some embodiments, the host logic 634 may include a coherence bridge 638, a home agent 639 and/or a memory controller 640. The host logic 634 may be implemented with hardware (e.g., dedicated hardware), software (e.g., running on the one or more processors 635), or a combination thereof. The memory controller 640 may control one or more portions of host memory 641.

The coherency bridge may be used to implement cache coherency between the host 601 and the computational device 604, for example, using a cache protocol such as CXL.cache. In some embodiments, a cache protocol may enable a device to access host memory, for example, in a cache coherent manner. Cache coherency may be maintained, for example, using one or more snooping mechanisms.

The home agent 639 may be used, for example, to implement a memory access protocol such as CXL.mem. In some embodiments, a memory access protocol may enable a host access to device attached memory (which may be referred to as host-managed device memory). In some embodiments, a memory access protocol may implement one or more coherence models such as a host coherent model, a device coherent model, a device coherent model using back-invalidation, and/or the like.

The I/O bridge 636 may be used to implement an I/O protocol (e.g., CXL.io), for example, as a non-coherent load/store interface for one or more I/O devices 637. In some embodiments, the IO bridge 636 may include an input-output memory management unit (IOMMU) 642 which may be used, for example, for DMA transactions.

The computational device 604 may include one or more compute resources 607, device logic 643, device memory 606, and/or a multiplexing circuit 620A. The device logic 643 may implement any of the host device functionality described herein. For example, the device logic 643 may implement coherence and/or cache logic for a memory access protocol (e.g., memory flows for CXL.mem) and/or a cache protocol (e.g., coherence requests for CXL.cache). Additionally, or alternatively, the device logic 643 may implement one or more of the following functionalities for an I/O protocol (e.g., CXL.io and/or PCIe): discovery (e.g., of device presence, types, features, capabilities, and/or the like), register access, configuration (e.g., configuration of device type, features, capabilities, and/or the like such as compute resources including hardware, software (downloaded, built-in, and/or the like), binary code, FPGA code, one or more operating systems, kernels, environments such as eBPF, and/or the like), interrupts, DMA transactions, error signaling, and/or the like.

In some embodiments, the device logic 643 may include a cache and/or cache agent 644 that may be used to implement one or more coherency mechanisms, and/or a data translation lookaside buffer (DTLB) 645 that may be used for address translations, for example, for addresses mapped to device memory 606. In some embodiments, the device logic 643 may include a memory controller 646 to control device memory 606 (e.g., device-attached memory, host-managed device memory, and/or the like). Depending on the implementation details, some or all of the host memory 641 and/or device memory 606 may be configured as system memory 686 (e.g., mapped as converged system memory).

In some embodiments, one or both of the multiplexers 620A and/or 620B may multiplex one or more of the memory access protocol (e.g., CXL.mem), cache protocol (e.g., CXL.cache) and/or I/O protocol (e.g., CXL.io) over one or more physical links 629 (e.g., over a single physical link). In some embodiments, one or both of the multiplexers 620A and/or 620B may implement dynamic multiplexing in which, for example, transactions using one or more of the CXL.io, CXL.mem, and/or CXL.cache protocols may be interleaved onto the physical link 629, depending on the implementation details, without reconfiguring, retraining, and/or the like, the physical link 629.

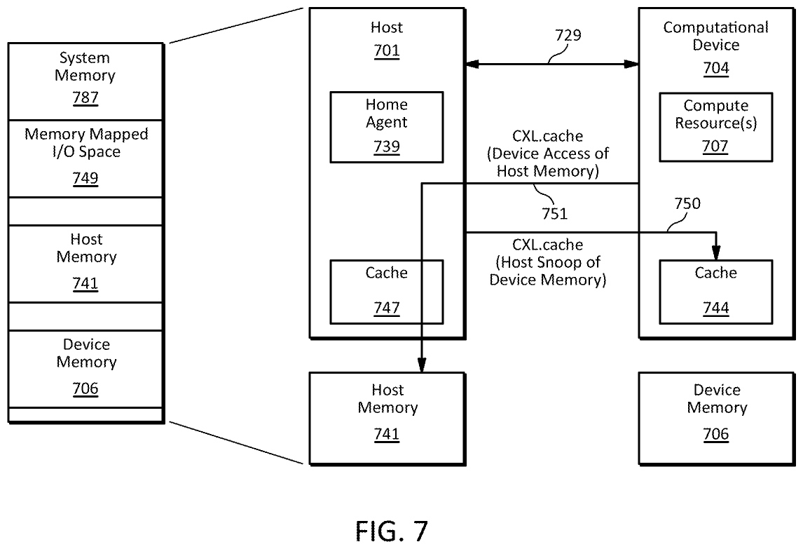

FIG. 7 illustrates an embodiment of a coherent interface scheme using a cache protocol in accordance with example embodiments of the disclosure. The embodiment illustrated in FIG. 7 may be used to implement, and/or may be implemented with the embodiments illustrated in FIG. 5, and/or FIG. 6 in which similar elements may be indicated by reference numbers ending in, and/or containing, the same digits, letters, and/or the like.

The embodiment illustrated in FIG. 7 may include a host 701 and/or a device 704 configured to communicate using a coherent interface link 729. The host 701, which may be configured to access host memory 741, may include a home agent 739 and a coherent cache 747. The device 704, which may be configured to access device memory 706, may include a coherent cache 744. In some embodiments, the host memory 741 and/or device memory 706 may be mapped to system memory 787 (e.g., converged memory) as illustrated in the system memory map on the left side of FIG. 7. In some embodiments, the system memory 787 may include a memory-mapped I/O space 749 which, in various embodiments, may or may not be configured as cacheable memory space.

In some embodiments, the device 704 may configure (e.g., expose) at least a portion of the device memory 706 as host and/or device cacheable (e.g., using cache 744 and/or a cache protocol for a coherent interface such as CXL.cache). In such an embodiment, cache coherency may be maintained, for example, using a snooping mechanism in which the host 701 may snoop the device cache 744 as shown by arrow 750. In such an embodiment, the device 701 may access at least a portion of host cache 747, for example, using CXL.cache as shown by arrow 751, and the host 701 may access the at least a portion of device memory 706, for example, using CXL.mem (e.g., operating as a CXL Type 2 device).

In some embodiments, the device 704 may configure at least a portion of the device memory 706 as device private. In such an embodiment, the device 701 may access at least a portion of host cache 747, for example, using CXL.cache (e.g., operating as a CXL Type 1 device).

The embodiment illustrated in FIG. 7 may be used, for example, to implement a computational device scheme in accordance with example embodiments of the disclosure. For example, in some embodiments, the device 704 may be implemented as a computational device having one or more compute resources 707. Using a cache protocol (e.g., CXL.cache) as illustrated in FIG. 7, the device 704 may obtain (e.g., fetch) input data for a computational operation from the host 701 and store the input data in the device cache 744. The device 704 may perform the computational operation using the input data stored in the device cache 744 as input for the computational operation by the one or more compute resources 707. The device 704 may store one or more results (e.g., a completion, output data, and/or the like) in the device cache 744 which may cause the host 701 to be notified of the completion of the computational operation, for example, based on a coherence mechanism, a snooping mechanism, and/or the like.

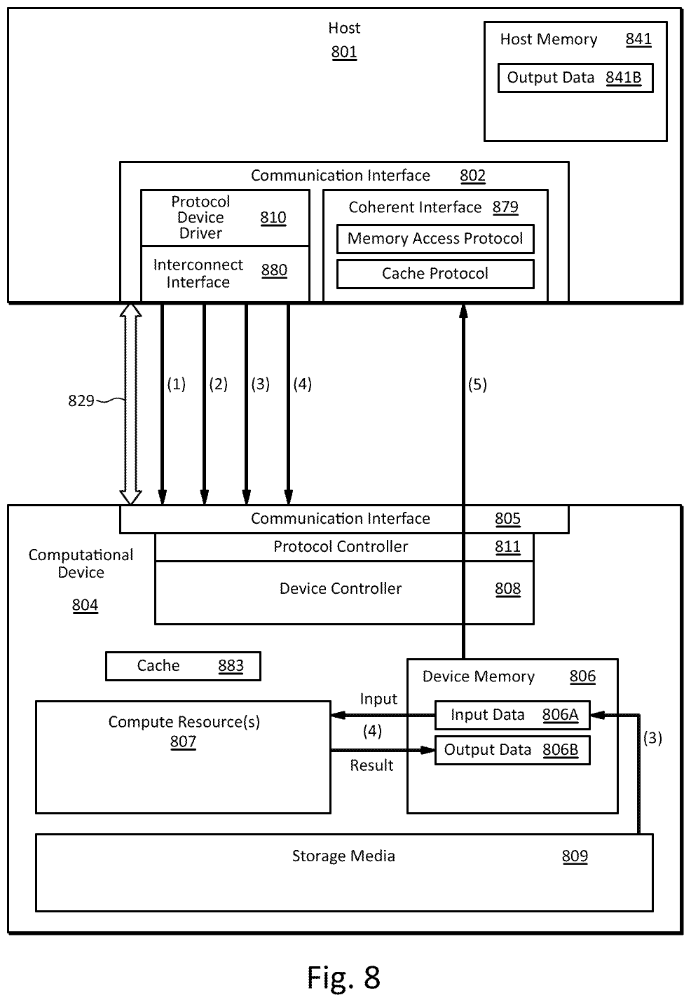

FIG. 8 illustrates a first embodiment of a computational device scheme using a coherent interface to transfer a result of an operation in accordance with example embodiments of the disclosure. The embodiment illustrated in FIG. 8 may include one or more elements similar to one or more elements illustrated in FIGS. 1 through 7 in which similar elements may be indicated by reference numbers ending in, and/or containing, the same digits, letters, and/or the like.

The embodiment illustrated in FIG. 8 may include a host 801 and/or a computational device 804 configured to communicate using a communication link 829. The host 801 may include a communication interface 802 and the device 804 may include a communication interface 805. For purposes of illustration, the computational device 804 may be implemented as a computational storage device in which at least a portion of a device functionality circuit may be implemented with storage media 809. In other embodiments, however, the computational device 804 may be implemented as any other type of device that may receive, store, generate, and/or the like, input data for a computational operation by one or more compute resources 807.

The communication interfaces 802 and/or 805 may be configured to implement a coherent interface 879 (e.g., CXL) that may implement one or more protocols such as a memory access protocol (e.g., CXL.mem) and/or a cache protocol (e.g., CXL.cache) using the communication link 829. The communication interfaces 802 and/or 805 may also be configured to implement an interconnect interface 880 (e.g., PCIe) using the communication link 829. For example, the coherent interface 879 and/or interconnect interface 880 may be implemented using a multi-mode scheme as illustrated, for example, in FIG. 3 and/or FIG. 4. Additionally, or alternatively, the coherent interface 879 and/or interconnect interface 880 may be implemented using a protocol stack such as that described with respect to FIG. 5, FIG. 6, and/or FIG. 7.

The embodiment illustrated in FIG. 8 may be used to implement an example computational operation in which a coherent interface may be used to transfer a result of the computational operation. For example, an amount of memory (e.g., 50 percent of device memory) may be configured to store one or more results (e.g., output data) of the computational operation. Some or all of the result memory may be located at the computational storage device 804, at the host 801, and/or at any other location.

For example, in some embodiments, a portion 806B of device memory 806 may be configured (e.g., by the host 801) as result (e.g., output data) memory to be accessed (e.g., by the host 801 and/or the computational storage device 804) with a coherent interface (e.g., CXL) using a memory access protocol (e.g., CXL.mem). In such an embodiment, the host 801 may identify the portion 806B to the computational storage device 804 so the one or more compute resources 807 may store one or more results of the computational operation in the portion 806B of device memory 806.

As another example, in some embodiments, a portion 806B of device memory 806 or other memory may be configured (e.g., by the host 801) as result (e.g., output data) memory to be accessed (e.g., by the host 801 and/or the computational storage device 804) with a coherent interface (e.g., CXL) using a cache protocol (e.g., CXL.cache). In such an embodiment, the portion 806B of device memory 806 may be configured (e.g., by the host 801) as cacheable memory.

Alternatively, or additionally, some or all of the result (e.g., output data) memory may be located in a portion 841B of host memory 841 at the host 801 and configured (e.g., by the host 801) to be accessed (e.g., by the host 801 and/or the computational storage device 804) with a coherent interface (e.g., CXL) using a cache protocol (e.g., CXL.cache). In such an embodiment, the computational storage device 804 may include a coherent cache 883 corresponding to the cacheable result memory 841B located at the host 801.

Using a result (e.g., output data) memory configured as described above, the example computational operation may proceed as follows. At operation (1), the host 801 (e.g., an application, process, service, virtual machine (VM), VM manager, operating system, and/or the like, running on the host 801) may send one or more configuration commands, instructions, and/or the like, to the computational storage device 804, for example, using the device driver 810 to implement a storage protocol (e.g., NVMe) over an interconnect (e.g., PCIe) interface 880 to configure the computational storage device 804 to perform a computational operation on data stored in the storage media 809. For example, the configuration command may cause the computational storage device 804 to download (e.g., from the host 801 and/or another source) a computational program, FPGA code, and/or the like, that may be used by the one or more compute resources 807 to perform the computational operation. Additionally, or alternatively, the configuration command may select, enable, activate, and/or the like) a computational program, FPGA code, and/or the like, that may be present at the computational storage device 804.

At operation (2), the host 801 may send a command (e.g., an allocate command using a storage protocol (e.g., NVMe) over the interconnect (e.g., PCIe) interface 880) to allocate a portion of the memory 806 as shared memory 806A to store input data for the computational operation. For example, a storage protocol (e.g., NVMe) controller 811 may implement a subsystem using the portion 806A of memory 806 as shared memory (e.g., shared SLM).

At operation (3), the host 801 may send a command (e.g., a load data command using a storage protocol over the interconnect interface 880) to cause the computational storage device 804 to load input data for the computational operation from the storage media 809 to the shared memory 806A.

At operation (4), the host 801 may send a command (e.g., an execute command using a storage protocol (e.g., NVMe) over the interconnect (e.g., PCIe) interface 880) to cause at least a portion of the one or more compute resources 807 to perform the computational operation using the input data stored in the shared memory 806A. The one or more compute resources 807 may store one or more results (e.g., output data) of the computational operation in portion 806B of device memory 806 (e.g., if the portion 806B is configured to be accessed with a memory access protocol such as CXL.mem or as cacheable memory using a cache protocol such as CXL.cache) and/or in a coherent cache at the computational storage device 804 corresponding to a cacheable result memory located at the host 801 (e.g., if the host 801 configured memory at the host 801 as cacheable memory to receive one or more results of the computational operation). The computational operation may use one or more memory pointers to determine the location(s) at which to store the one or more results of the computational operation. In some embodiments, the one or more pointers may be sent with, indicated by, and/or the like, an execute command.

At operation (5), the host 801 may obtain one or more results (e.g., output data) of the computational operation using the coherent interface 879 (e.g., CXL) that may be configured to use a memory access protocol such as CXL.mem and/or a cache protocol such as CXL.cache. For example, if some or all of the results of the computational operation are stored in a portion 806B of device memory 806 that may be configured to be accessed using a memory access protocol (e.g., CXL.mem), the host 801 may send a command to read the one or more results using CXL.mem. As another example, if some or all of the results of the computational operation are stored in a portion 806B of device memory 806 that may be configured to be accessed using a cache protocol (e.g., CXL.cache), or in a coherent cache at the computational storage device 804 corresponding to a cacheable result memory located at the host 801, some or all of the results may be made available to the host 801 (e.g., automatically) by a coherency mechanism such as a cache snooping mechanism.

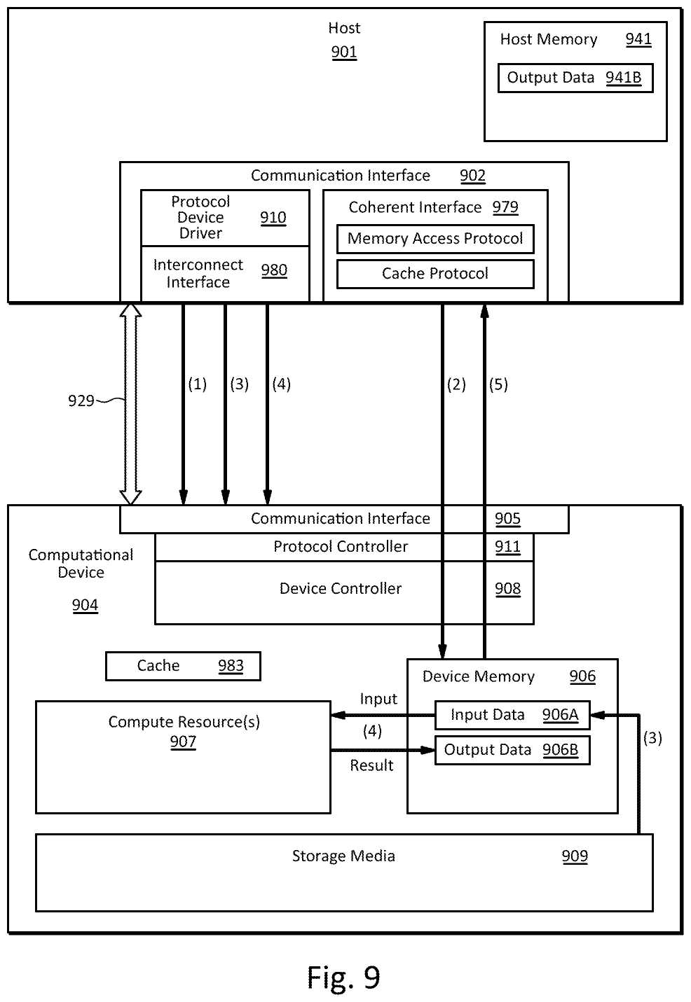

FIG. 9 illustrates a second embodiment of a computational device scheme using a coherent interface to transfer a result of an operation in accordance with example embodiments of the disclosure. The embodiment illustrated in FIG. 9 may include one or more elements similar to one or more elements illustrated in FIGS. 1 through 8 in which similar elements may be indicated by reference numbers ending in, and/or containing, the same digits, letters, and/or the like.

In some aspects, the embodiment illustrated in FIG. 9 may operate in a manner similar to the embodiment illustrated in FIG. 8, and the memory allocation for results and/or operations (1), (3), (4), and (5) illustrated in FIG. 9 may be performed in a similar manner to the corresponding memory allocation for results and/or operations (1), (3), (4), and (5) illustrated in FIG. 8.

However, in the embodiment illustrated in FIG. 9, at operation (2), the host 901 may send a command (e.g., an allocate command) to allocate memory to store input data for the computational operation using the coherent interface 979 (e.g., CXL) and a memory access protocol such as CXL.mem and/or a cache protocol such as CXL.cache. For example, at operation (2), the host 901 may send a command, using the coherent interface 979 and a memory protocol (e.g., CXL.mem) to allocate a portion 906A of device memory 906 as shared memory that may be used to store input data for the computational operation.

At operation (3), the computational storage device 904 may load (e.g., based on a load command received from the host 901) input data for the computational operation from the storage media 909 to the shared memory 906A which may be configured, for example, as host-managed device memory with CXL.mem as explained above. At operation (4), the one or more compute resources 907 may perform the computational operation using the input data stored in the shared memory 906A which may be configured, for example, as host-managed device memory with CXL.mem as explained above.

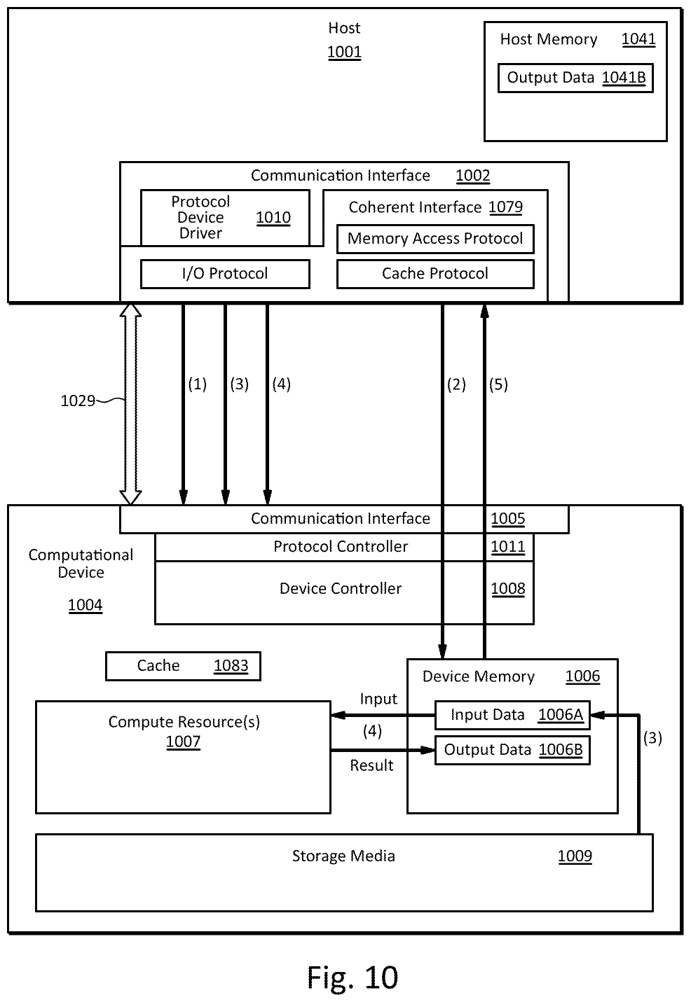

FIG. 10 illustrates a third embodiment of a computational device scheme using a coherent interface to transfer a result of an operation in accordance with example embodiments of the disclosure. The embodiment illustrated in FIG. 10 may include one or more elements similar to one or more elements illustrated in FIGS. 1 through 9 in which similar elements may be indicated by reference numbers ending in, and/or containing, the same digits, letters, and/or the like.

In some aspects, the embodiment illustrated in FIG. 10 may operate in a manner similar to the embodiment illustrated in FIG. 9. However, in the embodiment illustrated in FIG. 10, the storage protocol 1010 (e.g., NVMe) may be configured to use in I/O) protocol 1081 (e.g., as CXL.io) which may be implemented, for example, with the coherent interface 1079 (e.g., CXL).

Thus, rather than sending one or more commands using an interconnect (e.g., PCIe) portion of a multi-mode scheme as illustrated, for example, in FIG. 3, FIG. 4, FIG. 8, and/or FIG. 9, the embodiment illustrated in FIG. 10 may send one or more (e.g., all) commands using a coherent interface 1079 (e.g., CXL) that may implement an I/O protocol (e.g., as CXL.io), a memory access protocol (e.g., CXL.mem), and/or a cache protocol (e.g., CXL.cache). Moreover, one or more results of a computational operation may be sent to the Host 1001 using the coherent interface 1079 (e.g., CXL) and a memory access protocol (e.g., CXL.mem), and/or a cache protocol (e.g., CXL.cache).

In some embodiments, however, the communication interfaces 1002 and/or 1005 may implement an interconnect interface (e.g., PCIe) in addition to a coherent interface (e.g., CXL), for example, using a protocol stack such as that illustrated in FIG. 5.

In the embodiment illustrated in FIG. 10, an amount of memory (e.g., 50 percent of device memory) may be configured to store one or more results (e.g., output data) of the computational operation in a manner similar to that described above with respect to FIG. 8 and/or FIG. 9. Some or all of the result memory may be located at the computational storage device 1004, at the host 1001, and/or at any other location.

For example, in some embodiments, a portion 1006B of device memory 1006 may be configured (e.g., by the host 1001) as result (e.g., output data) memory to be accessed (e.g., by the host 1001 and/or the computational storage device 1004) with a coherent interface (e.g., CXL) using a memory access protocol (e.g., CXL.mem). In such an embodiment, the host 1001 may identify the portion 1006B to the computational storage device 1004 so the one or more compute resources 1007 may store one or more results of the computational operation in the portion 1006B of device memory 1006.

As another example, in some embodiments, a portion 1006B of device memory 1006 or other memory may be configured (e.g., by the host 1001) as result (e.g., output data) memory to be accessed (e.g., by the host 1001 and/or the computational storage device 1004) with a coherent interface (e.g., CXL) using a cache protocol (e.g., CXL.cache). In such an embodiment, the portion 1006B of device memory 1006 may be configured (e.g., by the host 1001) as cacheable memory.

Alternatively, or additionally, some or all of the result (e.g., output data) memory may be located at the host 1001 and configured (e.g., by the host 1001) to be accessed (e.g., by the host 1001 and/or the computational storage device 1004) with a coherent interface (e.g., CXL) using a cache protocol (e.g., CXL.cache). In such an embodiment, the computational storage device 1004 may include a coherent cache corresponding to the cacheable result memory located at the host 1001.

An example computational operation using the embodiment illustrated in FIG. 10 may proceed as follows. At operation (1), the host 1001 (e.g., an application, process, service, virtual machine (VM), VM manager, operating system, and/or the like, running on the host 1001) may send one or more configuration commands, instructions, and/or the like, to the computational storage device 1004, for example, using the device driver 1010 and a storage protocol (e.g., NVMe) using the coherent interface 1079 (e.g., CXL) and an I/O protocol (e.g., CXL.io) to configure the computational storage device 1004 to perform a computational operation on data stored in the storage media 1009. For example, the configuration command may cause the computational storage device 1004 to download (e.g., from the host 1001 and/or another source) a computational program, FPGA code, and/or the like, that may be used by the one or more compute resources 1007 to perform the computational operation. Additionally, or alternatively, the configuration command may select, enable, activate, and/or the like) a computational program, FPGA code, and/or the like, that may be present at the computational storage device 1004.

Alternatively, in some embodiments, the host 1001 may send a configuration command using a storage protocol (e.g., NVMe) over an interconnect (e.g., PCIe) interface.

At operation (2), the host 1001 may send a command (e.g., an allocate command using the coherent interface 1079 (e.g., CXL) and an I/O protocol (e.g., CXL.io)) to allocate memory and/or cache at the computational storage device 1004 to store input data for a computational operation using the coherent interface 1079 (e.g., CXL) and a memory access protocol (e.g., CXL.mem) or a cache protocol (e.g., CXL.cache). For example, the host 1001 may configure a portion 1006A of device memory 1006 as sharable host managed device memory using a memory access protocol (e.g., CXL.mem). As another example, the host 1001 may configure a portion 1006A of device memory 1006 as cacheable memory using a cache protocol (e.g., CXL.cache).

At operation (3), the host 1001 may send a command (e.g., a load data command using the coherent interface 1079 (e.g., CXL) and an I/O protocol (e.g., CXL.io)) to cause the computational storage device 1004 to load input data for the computational operation from the storage media 1009 to the shared and/or cacheable memory 1006A.

At operation (4), the host 1001 may send a command (e.g., an execute command using the coherent interface 1079 (e.g., CXL) and an I/O protocol (e.g., CXL.io)) to cause at least a portion of the one or more compute resources 1007 to perform the computational operation using the input data stored in the shared and/or cacheable memory 1006A. The one or more compute resources 1007 may store one or more results (e.g., output data) of the computational operation in portion 1006B of device memory 1006 (e.g., if the portion 1006B is configured to be accessed with a memory access protocol such as CXL.mem or as cacheable memory using a cache protocol such as CXL.cache) and/or in a coherent cache at the computational storage device 1004 corresponding to a cacheable result memory located at the host 1001 (e.g., if the host 1001 configured memory at the host 1001 as cacheable memory to receive one or more results of the computational operation). The computational operation may use one or more memory pointers to determine the location(s) at which to store the one or more results of the computational operation. In some embodiments, the one or more pointers may be sent with, indicated by, and/or the like, an execute command.

At operation (5), the host 1001 may obtain one or more results (e.g., output data) of the computational operation using the coherent interface 1079 (e.g., CXL) that may be configured to use a memory access protocol such as CXL.mem and/or a cache protocol such as CXL.cache. For example, if some or all of the results of the computational operation are stored in a portion 1006B of device memory 1006 that may be configured to be accessed using a memory access protocol (e.g., CXL.mem), the host 1001 may send a command to read the one or more results using CXL.mem. As another example, if some or all of the results of the computational operation are stored in a portion 1006B of device memory 1006 that may be configured to be accessed using a cache protocol (e.g., CXL.cache), or in a coherent cache at the computational storage device 1004 corresponding to a cacheable result memory located at the host 1001, some or all of the results may be made available to the host 1001 (e.g., automatically) by a coherency mechanism such as a cache snooping mechanism.

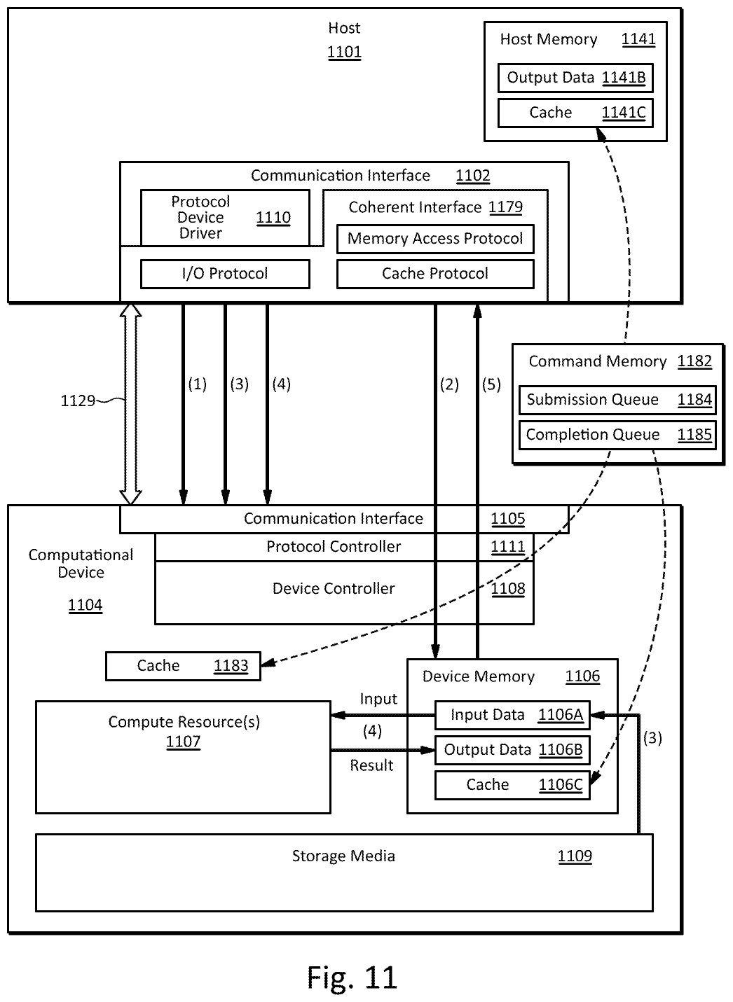

FIG. 11 illustrates a fourth embodiment of a computational device scheme using a coherent interface to transfer a result of an operation in accordance with example embodiments of the disclosure. The embodiment illustrated in FIG. 11 may include one or more elements similar to one or more elements illustrated in FIGS. 1 through 10 in which similar elements may be indicated by reference numbers ending in, and/or containing, the same digits, letters, and/or the like.

In some aspects, the embodiment illustrated in FIG. 11 may operate in a manner similar to the embodiment illustrated in FIG. 10. However, in the embodiment illustrated in FIG. 11, a shared and/or cacheable memory area 1182 (which may be referred to as a command memory) may be set up at the computational storage device 1104 and/or the host 1101 to exchange one or more commands between the computational storage device 1104 and the host 1101. For example, the host 1101 may configure a portion 1106C of device memory 1106 as cacheable memory using a coherent interface (e.g., CXL) and/or a cache protocol (e.g., CXL.cache) to use as command memory 1182. Alternatively, or additionally, the host 1101 may configure a portion 1141C of host memory 1141 as cacheable memory using a coherent interface (e.g., CXL) and/or a cache protocol (e.g., CXL.cache) to use as command memory 1182, in which case, the computational storage device 1104 may use a cache 1183 to store a copy (e.g., a coherent copy) of some or all of the command memory 1182.

In some embodiments, the host 1101 may send a command (e.g., an offloaded processing command to perform a computational operation) to the computational storage device 1104 by storing a command in the command memory 1182 which may be configured as a coherent cache. Depending on the implementation details, the computational storage device 1104 may automatically detect the command stored by the host, for example, using a snooping mechanism that may be implemented by a coherent cache protocol (e.g., CXL.cache). Based on detecting the command stored by the host 1101 in the command memory 1182, the computational storage device 1104 may fetch (e.g., read) the command from the command memory 1182 and proceed to process the command. In some embodiments, the computational storage device 1104 may send a completion to the host 1101, for example, by storing a completion in the command memory 1182 to notify the host 1101 that the computational storage device 1104 has received and/or completed the command.

In some embodiments, some or all of the command memory 1182 may be configured as one or more queues (e.g., submission queues, completion queues, and/or the like) that may be used to transfer commands, completions, and/or the like between the host 1101 and/or the computational storage device 1104. For example, a first portion of the command memory 1182 may be configured as one or more submission queues 1184 and/or one or more completion queues 1185. In some embodiments, one or more of the submission queues 1184 and/or completion queues 1185 may be configured, operated, and/or the like, for example, as NVMe submission queues, completion queues, and/or the like, but one or more of the queues may be implemented with any protocol.

An example computational operation using the embodiment illustrated in FIG. 11 may proceed as follows. An amount of memory may be configured to store one or more results (e.g., output data) of the computational operation in a manner similar to that described above with respect to FIG. 8, FIG. 9, and/or FIG. 10. Some or all of the result memory may be located at the computational storage device 1104 (e.g., portion 1106B), at the host 1001 (e.g., portion 1141B), and/or at any other location and may be configured, operated, and/or the like, using a memory access protocol (e.g., CXL.mem), a cache protocol (e.g., CXL.cache), and/or the like.

At operation (1), the host 1101 (e.g., an application, process, service, virtual machine (VM), VM manager, operating system, and/or the like, running on the host 1101) may send one or more configuration commands, instructions, and/or the like, to the computational storage device 1104 by storing a configuration command in a submission queue 1184 in command memory 1182. The computational storage device 1104 may detect the configuration command in the submission queue 1184, for example, by operation of a cache coherency mechanism (e.g., a snooping mechanism). The computational storage device 1104 may execute the configuration command, for example, by configuring the one or more compute resources 1107 in a manner similar to that described with respect to operation (1) in FIG. 10. The computational storage device 1104 may send, to the host, a completion corresponding to the configuration command, for example, by storing a completion in a completion queue 1185 in command memory 1182. The host 1101 may detect the completion, for example, by operation of a cache coherency mechanism (e.g., a snooping mechanism).

Alternatively, in some embodiments, the host 1101 may send a configuration command using a storage protocol (e.g., NVMe) over an interconnect (e.g., PCIe) interface.

At operation (2), the host 1101 may send a command (e.g., an allocate command) to the computational storage device 1104 by storing an allocation command in a submission queue 1184 in command memory 1182. The computational storage device 1104 may detect the allocation command in a manner similar to operation (1) and execute the allocation command, for example, by allocating a portion 1106A of device memory 1106 to store input data for a computational operation. For example, the host 1101 may configure a portion 1106A of device memory 1106 as sharable host managed device memory using a memory access protocol (e.g., CXL.mem). As another example, the host 1101 may configure a portion 1106A of device memory 1106 as cacheable memory using a cache protocol (e.g., CXL.cache). The computational storage device 1104 may send a completion corresponding to the allocation command to the host 1101 by storing a completion in a completion queue 1185 in command memory 1182. The host 1101 may detect the completion, for example, by operation of a cache coherency mechanism (e.g., a snooping mechanism).

At operation (3), the host 1101 may send a command (e.g., a load data command) to the computational storage device 1104 by storing a load command in a submission queue 1184 in command memory 1182. The computational storage device 1104 may detect the allocation command in a manner similar to operation (1) and execute the load command, for example, by loading input data for the computational operation from the storage media 1109 to the shared and/or cacheable input data memory 1106A. The computational storage device 1104 may send a completion corresponding to the load command to the host 1101 by storing a completion in a completion queue 1185 in command memory 1182. The host 1101 may detect the completion, for example, by operation of a cache coherency mechanism (e.g., a snooping mechanism).

At operation (4), the host 1101 may send a command (e.g., an execute command) to the computational storage device 1104 by storing an execute command in a submission queue 1184 in command memory 1182. The computational storage device 1104 may detect the execute command in a manner similar to operation (1) and execute the execute command, for example, by performing the computational operation using the input data stored in the shared and/or cacheable memory 1106A. The one or more compute resources 1107 may store one or more results (e.g., output data) of the computational operation in portion 1106B of device memory 1106 (e.g., if the portion 1106B is configured to be accessed with a memory access protocol such as CXL.mem or as cacheable memory using a cache protocol such as CXL.cache) and/or in a coherent cache at the computational storage device 1104 corresponding to a cacheable result memory located at the host 1101 (e.g., if the host 1101 configured memory at the host 1101 as cacheable memory to receive one or more results of the computational operation). The computational operation may use one or more memory pointers to determine the location(s) at which to store the one or more results of the computational operation. In some embodiments, the one or more pointers may be sent with, indicated by, and/or the like, an execute command. The computational storage device 1104 may send a completion corresponding to the execute command to the host 1101 by storing a completion in a completion queue 1185 in command memory 1182. The host 1101 may detect the completion, for example, by operation of a cache coherency mechanism (e.g., a snooping mechanism).

At operation (5), the host 1101 may obtain one or more results (e.g., output data) of the computational operation using the coherent interface 1179 (e.g., CXL) that may be configured to use a memory access protocol such as CXL.mem and/or a cache protocol such as CXL.cache. For example, if some or all of the results of the computational operation are stored in a portion 1106B of device memory 1106 that may be configured to be accessed using a memory access protocol (e.g., CXL.mem), the host 1101 may send a command to read the one or more results using CXL.mem. As another example, if some or all of the results of the computational operation are stored in a portion 1106B of device memory 1106 that may be configured to be accessed using a cache protocol (e.g., CXL.cache), or in a coherent cache 1183 at the computational storage device 1104 corresponding to a cacheable result memory 1141B located at the host 1101, some or all of the results may be made available to the host 1101 (e.g., automatically) by a coherency mechanism such as a cache snooping mechanism.

In some embodiments, a coherent interface in accordance with example embodiments of the disclosure may implement a link that may support protocol multiplexing (e.g., dynamic multiplexing) of one or more cache protocols (e.g., coherent cache protocols), memory access protocols, I/O) protocols, and/or the like. Depending on the implementation details, this may enable communication of coherent accelerators, memory devices (e.g., memory expansion devices), and/or the like, to one or more hosts, processing systems, and/or the like.

In some embodiments, a host may include a home agent which may resolve coherency (e.g., system-wide coherency) for a given address, and/or a host bridge which may control the functionality of one or more root ports. In some embodiments, a device may include a device coherency agent (DCOH) which may resolve coherency with respect to one or more device caches, manage bias states, and/or the like. In some embodiments, a DCOH may implement one or more coherency related functions such as snooping of a device cache based, for example, on one or more memory access protocol commands.

In some embodiments, a cache protocol (e.g., CXL.cache) may implement an agent coherency protocol that may support device caching of host memory. An agent may be implemented, for example, with one or more devices (e.g., accelerators) that may be used by a host (e.g., an application running on a host processor) to offload and/or perform any type of compute task, I/O task, and/or the like. Examples of such devices or accelerators may include programmable agents (e.g., a graphics processing unit (GPU), a general purpose GPU (GPGPU), fixed function agents, reconfigurable agents such as FPGAs, and/or the like.

A cache protocol for a coherent interface in accordance with example embodiments of the disclosure may implement one or more coherence models, for example, a device coherent model, a device coherent model with back-invalidation snoop, and/or the like. In an example device coherent with back-invalidation snoop model, a host may request access (e.g., exclusive access) to a cache line, and a device may initiate a back-invalidate snoop, for example, in a manner similar to that described below with respect to a memory access protocol for a coherent interface (e.g., CXL.mem).

In an example device coherent model for a cache protocol, one or more bias-based coherency modes may be used for host managed device memory. Examples of bias-based coherency modes may include a host bias mode, a device bias mode, and/or the like. In a host biased mode, device memory may appear as host memory. Thus, a device may access device memory by sending a request to the host which may resolve coherency for a requested cache line. For example, a copy of data in a first location (e.g., a device cache) may be updated based on a state (e.g., a modified state) of a copy of the data at a second location (e.g., a host cache).

In a device biased mode, a device (e.g., rather than a host) may have ownership of one or more cache lines. Thus, a device may access device memory without sending a transaction (e.g., a request, a snoop, and/or the like) to a host. A host may access device memory but may be give ownership of one or more cache lines to the device. A device bias mode may be used, for example, when a device is executing one or more computational operations (e.g., between work submission and work completion) during which it may be beneficial for the device to have relatively low latency and/or high bandwidth access to device memory.

In some embodiments, a memory access protocol for a coherent interface (e.g., CXL.mem) may be implemented as a transactional interface between a host and memory such as device memory which, in some implementations, may be configured as device-attached memory, for example, host-managed device memory.

A memory access protocol in accordance with example embodiments of the disclosure may implement one or more coherence models, for example, a host coherent model, a device coherent model, a device coherent model with back-invalidation snoop, and/or the like. In an example host coherent model, a device (e.g., a memory expansion device) may implement a memory region that may be exposed to a host, and the device may primarily service requests from a host. For example, the device may read and/or write data from and/or to device memory based on a request from a host and send a completion to the host.

In an example device coherent model, a device may implement a coherence model in which a device coherency agent (e.g., at the device) may resolve coherency with respect to device caches, managing bias states, and/or the like, in a manner similar to that described above with respect to a cache protocol for a coherent interface (e.g., CXL.cache).

In an example device coherent with back-invalidation snoop model, a host may request access (e.g., exclusive access) to a cache line. The device may initiate a back-invalidate snoop (e.g., using a DCOH) which may cause the host to invalidate the cache line at a host cache and send an invalidation acknowledgment to the device. Based on the acknowledgment, the device may transfer cache line data to the host which, depending on the implementation details, may ensure coherency of a cache at the host and memory at the device. Thus, depending on the implementation details, a copy of data in a first location (e.g., a host cache) may be updated based on a state (e.g., a modified state) of a copy of the data at a second location (e.g., a device memory).

In some embodiments, to implement a computational device scheme such as those described with respect to FIG. 8, FIG. 9, FIG. 10, and/or FIG. 11, a device may operate using a first coherency model (e.g., device coherent) to store results (e.g., output data) of a computational operation in shared device memory, and operate using a second coherency model (e.g., host coherent) in which a host may read one or more results (e.g., output data) from the shared device memory.

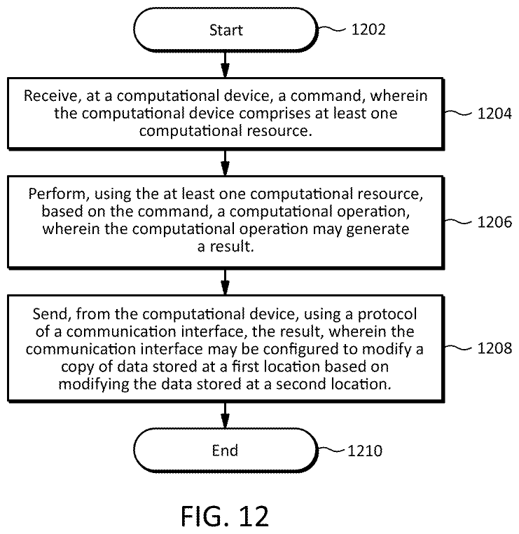

FIG. 12 illustrates an embodiment of a method for computational device communication using a coherent interface in accordance with example embodiments of the disclosure. The method may begin at operation 1202. At operation 1204, the method may receive, at a computational device, a command, wherein the computational device comprises at least one computational resource. For example, referring to FIG. 8, a computational device 804 having one or more compute resources 807 may receive, at operation (4), an execute command.

At operation 1206, the method may perform, using the at least one computational resource, based on the command, a computational operation, wherein the computational operation may generate a result. For example, referring to FIG. 8, the one or more compute resources 807 may execute, at operation (4) based on the execute command, the computational operation that may generate a result that may be stored in an output data portion 806B of device memory 806.

At operation 1208, the method may send, from the computational device, using a protocol of a communication interface, the result. For example, referring to FIG. 8, at operation (5) the computational device 804 may send a result of the computational operation using a memory access protocol (e.g., CXL.mem) and/or a cache protocol (e.g., CXL.cache) of a communication interface 802, the result stored in an output data portion 806B of device memory 806.

Also at operation 1208, the communication interface may be configured to modify a copy of data stored at a first location based on modifying the data stored at a second location. For example, the communication interface 802 may be implemented with a coherent interface such as CXL that may implement cache coherency, for example, by modifying a copy of data stored at a first location (e.g., a cache 883 at computational device 804) based on modifying the data stored at a second location (e.g., a cacheable memory area 841B in host memory 841). The method may end at operation 1210.

The embodiment illustrated in FIG. 12, as well as all of the other embodiments described herein, are example operations and/or components. In some embodiments, some operations and/or components may be omitted and/or other operations and/or components may be included. Moreover, in some embodiments, the temporal and/or spatial order of the operations and/or components may be varied. Although some components and/or operations may be illustrated as individual components, in some embodiments, some components and/or operations shown separately may be integrated into single components and/or operations, and/or some components and/or operations shown as single components and/or operations may be implemented with multiple components and/or operations.

Any of the functionality described herein, including any of the host functionality, device functionally, and/or the like, as well as any of the functionality described with respect to the embodiments illustrated in FIGS. 1-11 may be implemented with hardware, software, firmware, or any combination thereof including, for example, hardware and/or software combinational logic, sequential logic, timers, counters, registers, state machines, volatile memories such DRAM and/or SRAM, nonvolatile memory including flash memory, persistent memory such as cross-gridded nonvolatile memory, memory with bulk resistance change, PCM, and/or the like and/or any combination thereof, complex programmable logic devices (CPLDs), FPGAS, ASICs, CPUs including CISC processors such as x86 processors and/or RISC processors such as ARM processors, GPUs, NPUs, TPUs, and/or the like, executing instructions stored in any type of memory. In some embodiments, one or more components may be implemented as a system-on-chip (SOC), a multi-chip module, one or more chiplets (e.g., integrated circuit (IC) dies) in a package, and/or the like.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

1. A method comprising:
receiving, at a computational device, a command, wherein the computational device comprises at least one computational resource;
performing, using the at least one computational resource, based on the command, a computational operation, wherein the computational operation generates a result; and
sending, from the computational device, using a protocol of a communication interface, the result;
wherein the communication interface is configured to modify a copy of data stored at a first location based on modifying the data stored at a second location.

2. The method of claim 1, wherein:
the protocol comprises a memory access protocol; and
the sending the result is performed using the memory access protocol.

3. The method of claim 1, wherein:
the protocol comprises a cache protocol; and
the sending the result is performed using the cache protocol.

4. The method of claim 1, further comprising:
allocating, using the protocol, memory at the computational device; and
storing, in the memory, at least a portion of the result.

5. The method of claim 1, wherein the command is received using the protocol.

6. The method of claim 1, wherein the computational device comprises a memory, the method further comprising:
accessing, using the protocol, at least a portion of the memory; and
storing, in the at least a portion of the memory, the command.

7. The method of claim 1, wherein the communication interface is a first communication interface, the protocol is a first protocol, and the command is received using a second protocol of a second communication interface.

8. An apparatus comprising:
a computational device comprising:
a communication interface configured to modify a copy of data stored at a first location based on modifying the data stored at a second location;
at least one computational resource; and
a control circuit configured to:
receive a command;
perform, using the at least one computational resource, based on the command, a computational operation, wherein the computational operation generates a result; and
send, from the computational device, using a protocol of the communication interface, the result.

9. The apparatus of claim 8, wherein:
the protocol comprises a memory access protocol; and
the control circuit is configured to send the result using the memory access protocol.

10. The apparatus of claim 8, wherein:
the protocol comprises a cache protocol; and
the control circuit is configured to send the result using the cache protocol.

11. The apparatus of claim 8, wherein the control circuit is configured to:
allocate, using the protocol, memory at the computational device; and
store, in the memory, at least a portion of the result.

12. The apparatus of claim 8, wherein the control circuit is configured to receive the command using the protocol.

13. The apparatus of claim 8, wherein:
the computational device comprises a memory; and
the control circuit is configured to:
access, using the protocol, at least a portion of the memory; and
store, in the at least a portion of the memory, the command.

14. The apparatus of claim 8, wherein the communication interface is a first communication interface, the protocol is a first protocol, the computational device comprises a second communication interface, and the control circuit is configured to receive, using a second protocol of the second communication interface, the command.

15. An apparatus comprising:
a communication interface configured to modify a copy of data stored at a first location based on modifying the data stored at a second location; and
a control circuit configured to:
send, to a computational device, a command to perform a computational operation; and
receive, using a protocol of the communication interface, a result of the computational operation.

16. The apparatus of claim 15, wherein:
the protocol comprises a memory access protocol; and
the control circuit is configured to receive the result using the memory access protocol.

17. The apparatus of claim 15, wherein:
the protocol comprises a cache protocol; and
the control circuit is configured to receive the result using the cache protocol.

18. The apparatus of claim 15, wherein the control circuit is configured to allocate, using the protocol, for at least a portion of the result of the computational operation, memory at the computational device.

19. The apparatus of claim 15, wherein the control circuit is configured to send the command using the protocol.

20. The apparatus of claim 15, wherein the communication interface is a first communication interface, the protocol is a first protocol, the apparatus comprises a second communication interface, and the control circuit is configured to send, using a second protocol of the second communication interface, the command.
